(19) United States
(12) Patent Application Publication
(10) Pub. No.: US 2012/0151403 A1
(43) Pub. Date: Jun. 14, 2012

(54) MAPPING VIRTUAL DESKTOPS TO PHYSICAL MONITORS

(75) Inventors: Kulvir S. Bhogal, Pflugerville, TX (US); William A. Griffith, Austin, TX (US); Mark W. Talbot, Austin, TX (US)

(73) Assignee: INTERNATIONAL BUSINESS MACHINES CORPORATION, Armonk, NY (US)

(21) Appl. No.: 12/965,010

(22) Filed: Dec. 10, 2010

(51) Int. Cl. G06F 3/048

(52) U.S. Cl. 715/778

(57) ABSTRACT

Provided are techniques for generating mappings between virtual desktops of a computing system to physical display devices of the computing system such that a change in the configuration of the physical monitors coupled to the computing system triggers an implementation of the corresponding mapping. Also provided are persistent storage of the mappings and the implementation of the desktop to monitor mapping, based upon the stored mappings, upon startup of the computing system.

### FIELD OF DISCLOSURE

The claimed subject matter relates generally to computer displays and, more specifically, to techniques for mapping virtual desktops to physical monitors.

### SUMMARY

Although computers and monitors historically enjoyed a one-to-one relationship, in the current world of computers any particular computer may have multiple displays and even multiple possible configurations, each configuration associated with one or more displays. For example, a laptop computer that is “undocked” typically has a singe display, i.e. the built-in monitor. However, if a user inserts the laptop into a docking station there may be multiple additional displays attached to the docking station and employed either as alternatives or in addition to the original laptop display.

In addition to multiple displays, many users simultaneously run multiple applications and each application may be associated with one or more application windows. If a user has multiple monitors, different applications can be displayed on different monitors. As applications, windows and monitors have increased in number, one technique of addressing potential display clutter is the implementation of virtual desktops.

A “desktop” is typically displayed on one computer monitor and may include multiple windows. Virtual desktops enable a user to define multiple desktops, each potentially configured differently, and to switch a display among the different virtual desktops. A desktop manager may display a smaller version of all available desktops, or “contexts,” and enable a user to select which of several desktops to display at any particular time. In addition, controls, such as on-screen control bars, may enable a user to switch between a desktop manager and available desktops and to create and delete virtual desktops.

Currently, the configuration of virtual desktops and particularly the assignment of specific desktops to particular monitors in a multi-monitor configuration must be done manually. In addition, if a user selects a desirable configuration by moving available virtual desktops to particular monitors and then changes the monitor configuration, for example by removing a laptop from a docking station, the configuration returns to a default setting. If the user were to then re-dock the laptop, the selected configuration is not restored. Although it may be common to restore a configuration of physical monitors, currently there is no procedure, in general, for the restoration of virtual desktops to physical monitors and, specifically, for such a restoration in the event the configuration of physical monitors has changed during an undocking.

Provided are techniques for controlling computing displays. The techniques include logic for generating a plurality of virtual desktops corresponding to a computing device; generating a plurality of computer display configurations corresponding to possible groupings of a plurality of computer displays corresponding to the computing device; generating a first virtual desktop to monitor (DT2M) mapping, associated with a first computer display configuration of the plurality of computer display configurations, by associating each virtual desktop of the plurality of virtual desktops to a corresponding computer display of the plurality of computer displays; generating a second virtual desktop to monitor (DT2M) mapping, associated with a second computer display configuration of the plurality of computer display configurations, by associating each virtual desktop of the plurality of virtual desktops to a corresponding computer display of the plurality of computer displays; implementing the first DT2M mapping in response to a detection that the computing device is configured in the first computer display configuration; and implementing the second DT2M mapping in response to a detection that the computing device is configured in the second computer display configuration.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures, in which:

FIG. 1 is a block diagram of one example of a computing architecture that may support the disclosed techniques.

FIG. 2 is a block diagram of a monitor configuration manager (MCM), first introduced above in FIG. 1 that implements the claimed subject matter.

FIG. 3 is an illustration of one example of a monitor configured to display multiple virtual desktops.

FIG. 4 is an illustration of three (3) monitors, or displays, first introduced above in conjunction with FIG. 1, and used as examples to describe of the functionality of the claimed subject matter.

FIG. 5 is a flowchart of processing associated with the MCM, introduced above in conjunction with FIGS. 1 and 2.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks.

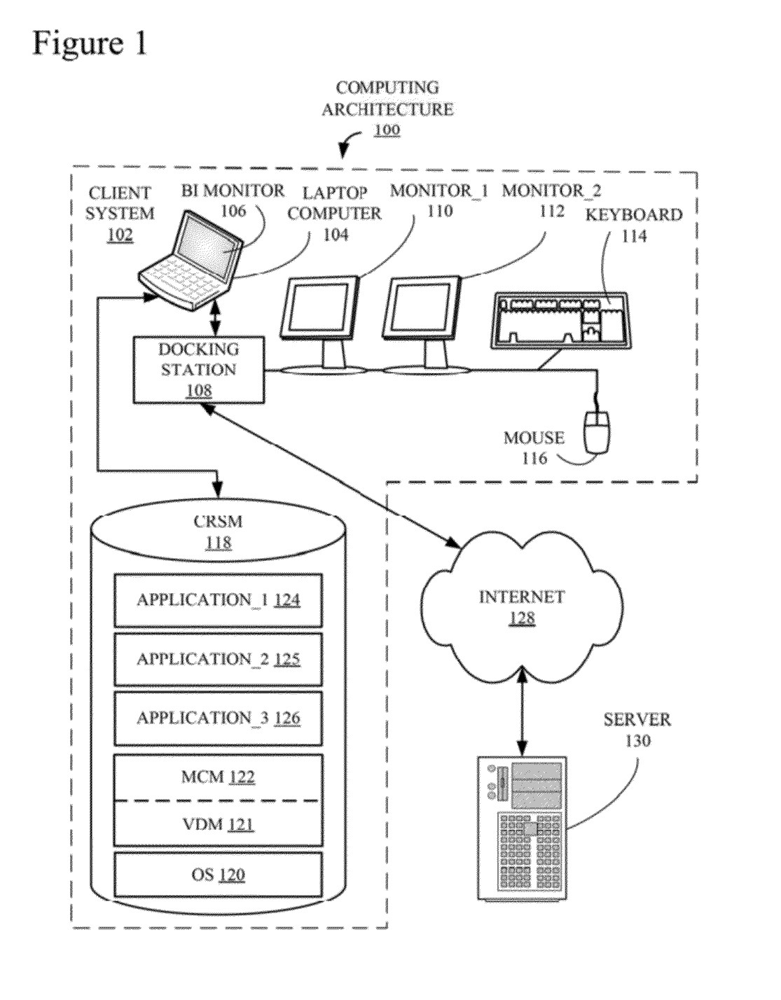

Turning now to the figures, FIG. 1 is a block diagram of a computing architecture 100 that incorporates the claimed subject matter. A client system 102 includes a laptop computer, or simply “laptop.” 104 with a built-in (DI) monitor 106 and a docking station 108. Docking station 108 provides connectivity for laptop 104 to auxiliary monitors, or a monitor_110 and a monitor_2 112, an auxiliary keyboard 114 and an auxiliary pointing device, or “mouse,” 116. It should be noted that laptop 104 includes a central processing unit, or “processor,” (not shown) a keyboard and some type of pointing device, which, for the sake of simplicity, are not labeled. Monitors 110 and 112, keyboard 114, mouse 116, BI monitor 106, and any built-in keyboard and pointing device facilitate human interaction with computing system 100, client system 102 and laptop 104.

Also included in laptop 104 is a computer-readable storage medium (CRSM) 118, which would typically be configured as an internal device but, for the sake of convenience, is illustrated separately. Of course, client system 102 may also include other storage devices, either internal devices, or attached externally to laptop 104 and/or docking station 108 by means of various, commonly available connection devices such as but not limited to, a universal serial bus (USB) port (not shown).

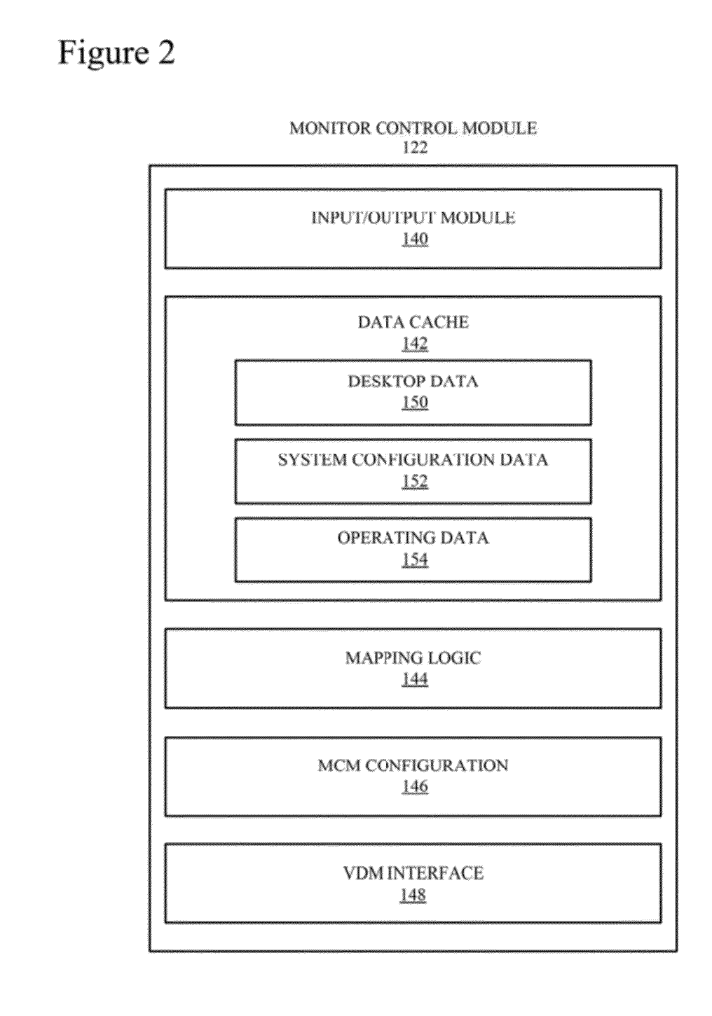

CRSM 118 is illustrated storing an operating system 120, a virtual desktop manager (VDM) 121, a monitor configuration module (MCM) 122 and three (3) computer software applications, specifically an application_1 124, application_2 125 and an application_3 126. OS 120 may be any available operating system and will be familiar to those with skill in the relevant arts. VDM 121 enable a user to manage virtual desktops and is illustrated having a MCM 122 component, which implements the claimed subject matter It should be noted that both VDM 12 land MCM 122 may be implemented as components of OS 120, separate programs, plug-in modules or implemented in hardware. MCM 122 is described in more detail below in conjunction with FIGS. 2-5. Applications 124, 125 and 126 are used through the description as examples. It should be noted that a typical computing system would include more than three applications but for the following examples three are sufficient.

Docking station 108 and therefore client system 102 are connected to the Internet 128, which is also connected to a server computer 130. When laptop 104 is inserted into, or “docked with,” docking station 108, a connection is established between laptop 104 and both the Internet 128 and server 130. Although in this example, docking station 108 and server 130 are communicatively coupled via the Internet 128, they could also be coupled through any number of communication mediums such as, but not limited to, a wide area network (WAN) (not shown) and a local area network (LAN) (not shown). Further, it should be noted there are many possible computing system configurations, of which computing system 100 is only one simple example. Although described with respect to a laptop computer, many computing system may have multiple possible display configurations, both default and optional. For example, a computing device such as a laptop may be part of a larger system that includes multiple monitors and different devices such as a desktop computer, a server and a tablet or slate computer.

FIG. 2 is a block diagram of MCM 122, introduced above in FIG. 1, in greater detail. MCM 122 includes several components including an input/output (I/O) module 140, data cache 142, mapping logic 144, MCM configuration 146 and VDM interface 148. For the sake of the following examples, MCM 122 is assumed to be stored in CRSM 116 and executed on laptop 104 (FIG. 1) as part of VDM 121 (FIG. 1). It should be understood that the claimed subject matter can be implemented in many types of computing systems and data storage structures but, for the sake of simplicity, is described only in terms of laptop 104 and system architecture 100 (FIG. 1). As mentioned above in conjunction with FIG. 1, MCM 122 may be integrated into VDM 121, OS 120 or a separate component. Further, the representation of MCM 122 in FIG. 2 is a logical model. In other words, components 140, 142, 144, 146 and 148 may be stored in the same or separates files and loaded and/or executed within system 100 either as a single system or as separate processes interacting via any available inter process communication (IPC) techniques.

I/O module 140 handles communication between MCM 122 and any other component of system 100. Data cache 142 is a data repository for information, including configuration settings and lists of potential monitors that MCM 122 utilizes during setup and operation. Examples of the types of information stored in data cache 142 include desktop data 150, system configuration data 152 and operation data 154. Desktop data 150 stores information associated with defined desktops including, but not limited to, information such as the names of programs or applications displayed on each particular desktop and desktops that have been designated for particular handling with respect to monitor configuration by MCM 122. System data 152 stores information about both hardware associated with laptop 104 and potential and actual display devices. Operation data 154 is a temporary data area employed by MCM 122 during operations, including intermediate results of current activities.

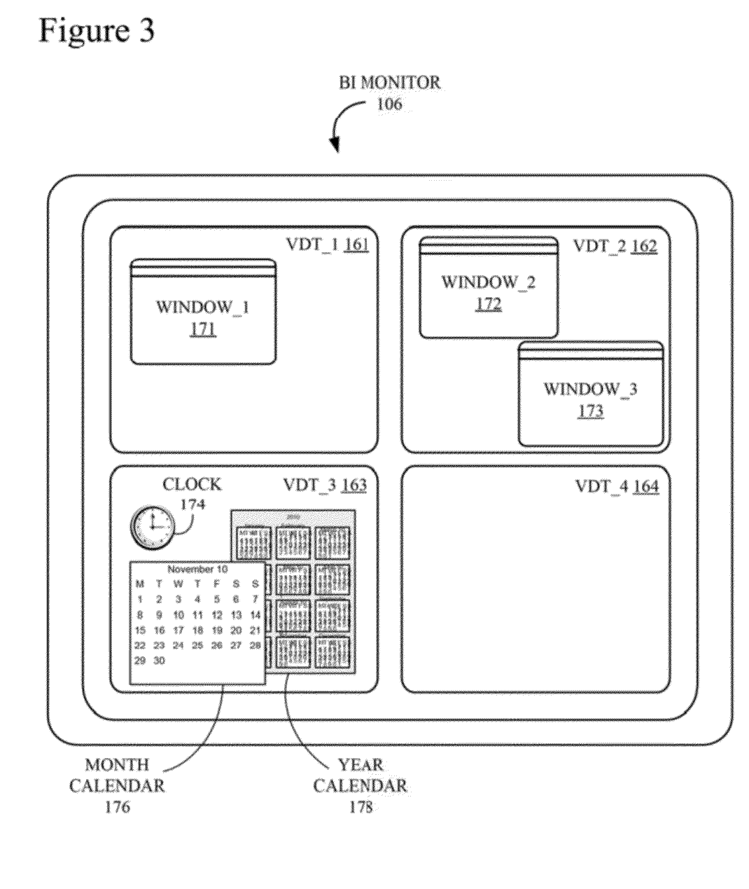

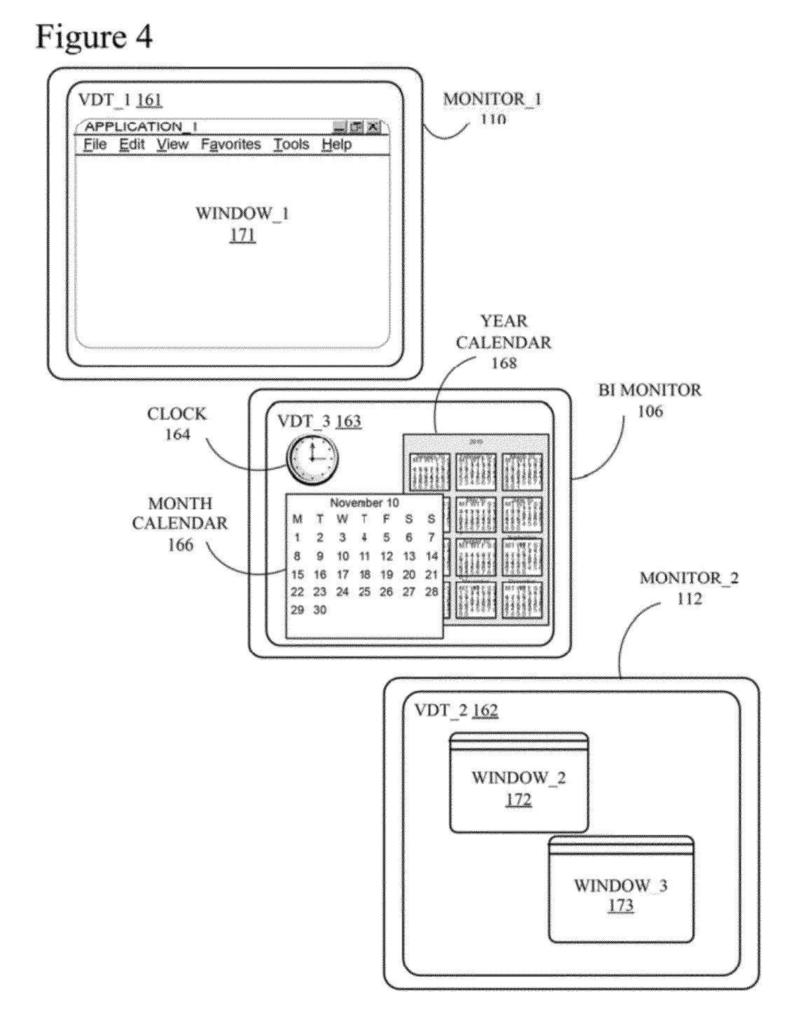

Mapping logic 144 generates, based upon data stored in data cache 142, a map of desktops to physical monitors (see FIGS. 3 and 4). Such calculation is performed when an event of interest to MCM 122 is detected. Two examples of such events are the docking and the undocking of laptop 104 (FIG. 1) from docking station 108 (FIG. 1). When an undocking is detected, typically via interrupt handling associated with OS 120 (FIG. 1) or MCM 122, mapping logic 144 stores the current configuration and, when a docking is detected, mapping logic 144 generates instructions to display particular desktops on particular monitors. Data stored in conjunction with MCM Configuration 146 controls the configuration of MCM 122 during operations. VDM interface 148 handles communication between MCM 122 and VDM 121 (FIG. 1). Components 140, 142, 144, 146, 148, 150, 152 and 154 are described in more detail below in conjunction with FIGS. 3-5.

FIG. 3 is a block diagram of showing BI monitor 106, first introduced above in conjunction with FIG. 1. In this example, BI monitor 106 is configured in a desktop manager mode in which four (4) virtual desktops (VDTs) are displayed, i.e. a VDT_1 161, a VDT_2 162 a VDT_3 163 and a VDT_4 164. VDT_1 161 is illustrated as displaying a first window, i.e. window_1 171, which in the following example is associated with application_1 124 (FIG. 1). VDT_2 162 is illustrated displaying a second window, i.e. window_2 172, associated with application_2 125 (FIG. 1) and a third window, i.e. window_3 173, associated with application_3 126 (FIG. 1). VDT_3 163 is illustrated displaying several graphic displays, i.e. a clock 174, a month calendar 176 and a year calendar 188. Graphic displays 174, 176 and 178 may be associated with one or more applications (not shown) or provided in conjunction with OS 118 (FIG. 1). Display elements such as elements 171, 172, 173, 174, 176 and 178 will be familiar to those with skill in the relevant arts and are used throughout this description merely as examples to explain the functionality of the claimed subject matter.

FIG. 4 is a block diagram of BI monitor 106, monitor_1 110 and monitor_2 112, first introduced above in conjunction with FIG. 1. In this example, monitors 106, 110 and 112 are coupled to laptop 104 and each display a different virtual desktop. Specifically, monitor_1 110 is displaying a VDT_1 161, including winw_1 171, monitor_2 112 is displaying VDT_2 162, including window_2 172 and window_3 173, and BI monitor 106 is displaying VDT_3 163, including graphic displays 164, 166 and 168. Virtual desktops, such as elements 161, 162 and 163, and their distribution among multiple monitors, such as monitors 106, 110 and 112, will be familiar to those with skill in the relevant arts and are used throughout this description merely as examples to explain the functionality of the claimed subject matter.

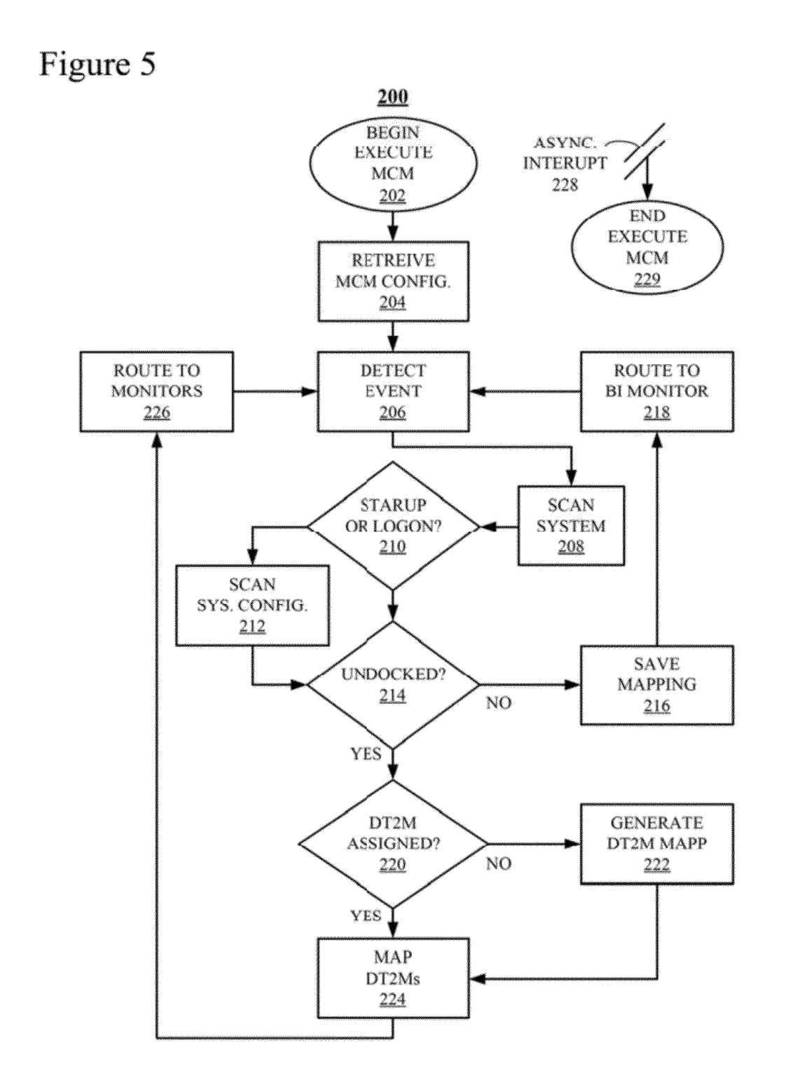

FIG. 5 is a flowchart of an Execute MCM process 200 associated with MCM 122 (FIGS. 1 and 2). In this example, logic associated with process 200 is stored on. CRSM 118 (FIG. 1) as part of MCM 122 and executed on a processor (not shown) of laptop 104 (FIG. 1). In the alternative, process 200, as well as MCM 122 may be incorporated into VDM 120 (FIG. 1) or OS 120 (FIG. 1).

Process 200 starts in a “Begin Execute MCM” block 202 and proceeds immediately to a “Retrieve MCM Configuration (Config.)” block 204. During processing associated with block 204, process 200 retrieves information necessary for the operation of MCM 122 from MCM configuration 146 (FIG. 2). During processing associated with a “Detect Event” block 206, process 200 waits for an event that signals a change in display configuration, typically detected as the result of an OS interrupt handler. In this example, types of events include, but are not limited to, a computer startup, a logon event in which a user logs on to laptop 104, a docking event in which laptop 104 is inserted into docking station 108 and an undocking event in which laptop 104 is removed from docking station 108. Other types of possible events include the connection and disconnection of a monitor. It should be noted that although described in conjunction with laptop 104 and a few types of events, the claimed subject matter is equally applicable to other types of computing systems and other events associated with displays. For example, a display may be connected to a computer via a wireless connection (not shown) or network.

During processing associated with a “Scan System” block 208, process 200 determines both the type of event that was received during block 206 and the current system configuration, particularly with respect to the docking status, connected monitors and the assignment of applications to desktops and desktops to connected monitors. This processing is executed in conjunction with VDM interface 148 (FIG. 2). During processing associated with a “Startup or Logon?” block 210, process 200 determines whether or not the event detected during processing associated with block 206 is a startup of laptop 104 or a user logging on to laptop 104. If so, control proceeds to a “Scan System Configuration (Sys. Config.)” block 212. During processing associated with block 212, process 200 retrieves information from system configuration 152 (FIG. 2) to enable a display setup that has been stored from a previous session of the user on laptop 104. In this manner, the user does not need to reconfigure a desktop to monitor mapping each time a computing session is initiated.

Once system configuration 152 has been loaded during processing associated with block 212 or, if during processing associated with block 210, it is determined that the event detected during block 206 is not a startup or user logon event, control proceeds to an “Undocked?” block 214. During processing associated with block 214, process 200 determines whether or not laptop 104 is uncoupled from docking station 108. If so, process 200 proceeds to a “Save Mapping” block 216. During processing associated with block 216, current desktop to monitor mapping as determined during block 208, such as the mapping described above in conjunction with FIG. 3, is saved to operating data 154 for future use. Once configuration and mapping information has been saved during processing associated with block 216, process 200 proceeds to a “Route to Built-In (BI) Monitor” block 218 and laptop 104 is configured to display, in this example, the display illustrated above in FIG. 3. Control then returns to Detect Event 206 and processing continues as described above and below.

If during processing associated with block 214, process 200 determines that laptop 104 is coupled to docking station 108 control proceeds to a “Desktop to Monitor (DT2M) Assigned?” block 220. During processing associated with block 220, process 200 determines whether or not the configuration detected during processing associated with block 208 corresponds to a particular configuration saved in application data 150 (FIG. 2), system configuration data 152 and/or operating data 154. In the event of conflicting configurations, data stored in MCM configuration 146 (FIG. 2) is employed to resolve the issue. For example, data stored in operating data 154 from the last instance of a similar monitor configuration may be given precedence over configuration mappings stored with respect to particular applications in application data 150, which may be given precedence over data stored in system configuration data 152.

If it is determined during block 220 that there is either no mapping that corresponds to the current monitor configuration, control proceeds to a “Generate DT2M Map” block 222. During processing associated with block 222, process 200, if possible, generates a mapping based upon rules stored in MCM configuration 146 and information stores in data cache 142 (FIG. 2). Of course, one option specified by MCM configuration 146 may be to not map specific desktops to monitors in the event there is no specific mapping assigned. During processing associated with block “Map DT2Ms” block 224, process 200 assigns virtual desktops, such as 161-164 (FIG. 3) to monitors, such as monitors 106, 110 and 112 in accordance with either an assigned configuration or a configuration generated during processing associated with block 222. During processing associated with a “Route to Monitors” block 226, process 200, in conjunction with VDM interface 148, implements the mapping generated during block 224.

Finally, process 200 is halted by means of an asynchronous (async.) interrupt 228, which passes control to an “End Execute MCM” block 229 in which process 200 is complete. Interrupt 228 is typically generated when the OS, browser, application, etc. of which process 200 is a part is itself halted. During normal operation, process 200 continuously loops through the illustrated blocks of FIG. 4, detecting and processing events associated with logins, docking and undocking of laptop 104 and the connection and disconnection of display devices.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method of controlling computing displays, comprising:
generating a first virtual desktop to monitor (DT2M) mapping, associated with a first display configuration, by associating each virtual desktop of a plurality of virtual desktops to a corresponding display device associated with the first display configuration, wherein the first display configuration corresponds to a first subset of a plurality of display devices;
generating a second virtual desktop to monitor (DT2M) mapping, associated with a second display configuration, by associating each virtual desktop of the plurality of virtual desktops to a corresponding display device associated with the second display configuration, wherein the second display configuration corresponds to a second subset, different than the first subset, of the plurality of display devices;
implementing the first DT2M mapping in response to a detection that the computing device is configured in the first display configuration; and
implementing the second DT2M mapping in response to a detection that the computing device is configured in the second display configuration.

2. The method of claim 1 wherein the first DT2M mapping and the second DT2M mapping are stored in a persistent, computer-readable storage medium and available at startup of the computing device.

3. The method of claim 2, further comprising:
retrieving the first and second DT2M mappings from the of the persistent, computer-readable storage medium;
detecting whether the computing device is in the first or second display configuration; and
implementing either the first or second DT2M mapping based upon the detection of the corresponding first or second display configuration.

4. The method of claim 3, wherein the retrieving of the first or second computer display configuration, the detecting of whether the computing device is in the first or second computer display configuration and the implementing of either the first or second DT2M mapping based upon the detection of the corresponding first or second computer display configuration are executed at startup of the computing device.

5. The method of claim 1 wherein the first display configuration includes a display device of the plurality of display devices that is not included in the second display configuration.

6. The method of claim 1, wherein the computing device is a portable computing device and the detections of a change in the display configuration correspond to either the insertion of the computing device into a docking station or the removal of the computing device from the docking station.

7. The method of claim 1, wherein at least one of the display devices is wireless.

8. An apparatus of controlling computing displays, comprising:
a computing device, comprising:
a processor;
a computer-readable storage medium;
a plurality of virtual desktops;
a plurality of display devices; and
a plurality of display configurations corresponding to possible subsets of the plurality of display devices; and
logic, stored on the computer-readable storage medium, which when executed on the processor:
generates a first virtual desktop to monitor (DT2M) mapping, associated with a first display configuration of the plurality of display configurations, by associating each virtual desktop of the plurality of virtual desktops to a corresponding display device of a first subset of the possible subsets;
generates a second virtual desktop to monitor (DT2M) mapping, associated with a second display configuration of the plurality of display configurations, by associating each virtual desktop of the plurality of virtual desktops to a corresponding display device of a second subset of the possible subsets;
implements the first DT2M mapping in response to a detection that the computing device is configured in the first display configuration; and
implements the second DT2M mapping in response to a detection that the computing device is configured in the second display configuration.

9. The apparatus of claim 8, wherein the first DT2M mapping and the second DT2M mapping are stored in a persistent, computer-readable storage medium and available at startup of the computing device.

10. The apparatus of claim 9, the logic further comprising logic, which when executed on the processor:
retrieves the first and second DT2M mappings from the of the persistent, computer-readable storage medium;
detects whether the computing device is in the first or second display configuration; and
implements either the first or second DT2M mapping based upon the detection of the corresponding first or second display configuration:

11. The apparatus of claim 10, wherein the logic for retrieving of the first or second display configuration, the detecting of whether the computing device is in the first or second display configuration and the implementing of either the first or second DT2M mapping based upon the detection of the corresponding first or second display configuration are executed at startup of the computing device.

12. The apparatus of claim 8 wherein the first display configuration includes a display device of the plurality of display devices that is not included in the second display configuration.

13. The apparatus of claim 8, wherein the computing device is a portable computing device and the detections of a change in the display configuration correspond to either the insertion of the computing device into a docking station or the removal of the computing device from the docking station.

14. The apparatus of claim 8, wherein at least one of the display devices is wireless.

15. A computer program product for controlling computing displays, the computer program product comprising:
a computer-readable storage medium having computer readable program code embodied therewith, the computer readable program code comprising computer readable program code configured to:
generate a first virtual desktop to monitor (DT2M) mapping, associated with a first display configuration, by associating each virtual desktop of a plurality of virtual desktops to a corresponding display device associated with the first display configuration, wherein the first display configuration corresponds to a first subset of a plurality of display devices;
generate a second virtual desktop to monitor (DT2M) mapping, associated with a second display configuration, by associating each virtual desktop of the plurality of virtual desktops to a corresponding display device associated with the second display configuration, wherein the second display configuration corresponds to a second subset, different than the first subset, of the plurality of display devices;
implement the first DT2M mapping in response to a detection that the computing device is configured in the first display configuration; and
implement the second DT2M mapping in response to a detection that the computing device is configured in the second display configuration.

16. The computer program product of claim 15, wherein the first DT2M mapping and the second DT2M mapping are stored in a persistent, computer-readable storage medium and available at startup of a computing device.

17. The computer programming product of claim 16, the computer readable program code further comprising computer readable program code configured to:
retrieve the first and second DT2M mappings from the of the persistent, computer-readable storage medium;
detect whether the computing device is in the first or second computer display configuration; and
implement either the first or second DT2M mapping based upon the detection of the corresponding first or second computer display configuration.

18. The computer programming product of claim 17, wherein the computer readable program code comprising computer readable program code configured to retrieve of the first or second computer display configuration, detect of whether the computing device is in the first or second computer display configuration and implement of either the first or second DT2M mapping based upon the detection of the corresponding first or second computer display configuration are executed at startup of the computing device.

19. The computer programming product of claim 15 wherein the first computer display configuration includes a computer display of the plurality of computer displays that is not included in the second computer display configuration.

20. The computer programming product of claim 15, wherein the computing device is a portable computing device and the detections of a change in the display configuration correspond to either the insertion of the computing device into a docking station or the removal of the computing device from the docking station.
